(19) United States
(12) Patent Application Publication
(10) Pub. No.: US 2025/0390999 A1
(43) Pub. Date: Dec. 25, 2025

(54) SYSTEMS AND METHODS FOR REDUCING HALO ARTIFACTS

(71) Applicant: GoPro, Inc., San Mateo, CA (US)

(72) Inventor: Robert McIntosh, Marina Del Rey, CA (US)

(21) Appl. No.: 18/452,730

(22) Filed: Aug. 21, 2023

(51) Int. Cl. G06T 5/00

(52) U.S. Cl. CPC G06T 5/80; G06T 5/70; G06T 5/73

(57) ABSTRACT

An image/video captured by an image capture device may depict an object with a halo artifact. The halo artifact within the image/video may be blurred using a mask. A high-fidelity version of the image/video may be generated by enhancing the blurred image/video. Super-resolution or sharpening may be applied to the blurred image/video to generate the high-fidelity version of the image/video. The high-fidelity version of the image/video may depict the object with a reduced halo artifact, which has a smaller visual impact than the halo artifact in the original image/video.

### FIELD

This disclosure relates to reducing halo artifacts in images and videos.

### BACKGROUND

Images/videos captured by an image capture device may include halo artifacts, such as a result of sharpening applied to the images/videos. Halo artifacts may distract from the target content within the images/videos.

### SUMMARY

This disclosure relates to reducing halo artifacts. Visual information and/or other information may be obtained. The visual information may define visual content of one or more images. The visual content may depict one or more objects with a halo artifact. A mask for the visual content may be generated. The mask may be generated to target edges depicted within the visual content. Blurred visual content may be generated based on blurring of the edges depicted within visual content using the mask. The blurring of the edges depicted within the visual content may blur the halo artifact. High-fidelity visual content may be generated based on enhancement of the blurred visual content. The high-fidelity visual content may include more detailed depiction of the object(s) than the visual content. The high-fidelity visual content may depict the object(s) with a reduced halo artifact. The reduced halo artifact may have a smaller visual impact than the halo artifact.

A system for reducing halo artifacts may include one or more electronic storages, one or more processors, and/or other components. An electronic storage may store visual information, information relating to visual content, information relating to halo artifacts, information relating to masks, information relating to blurring visual content, information relating to enhancement of visual content, and/or other information.

The processor(s) may be configured by machine-readable instructions. Executing the machine-readable instructions may cause the processor(s) to facilitate reducing halo artifacts. The machine-readable instructions may include one or more computer program components. The computer program components may include one or more of a visual information component, a mask component, a blur component, a high-fidelity component, and/or other computer program components.

The visual information component may be configured to obtain visual information and/or other information. The visual information may define visual content of one or more images. In some implementations, the image(s) may be video frame(s) of a video. The visual content may depict one or more objects with a halo artifact. In some implementations, the halo artifact may include an increase in contrast of the edges depicted within the visual content.

In some implementations, the visual content may depict the object(s) with the halo artifact(s) based on sharpening applied to generate the visual content. The sharpening may be applied by an image capture device during capture of the visual content. The image capture device may not provide an option for a user to adjust an amount of the sharpening applied to generate the visual content. The image capture device may not provide an option for a user to turn off the sharpening applied to generate the visual content.

The mask component may be configured to generate a mask for the visual content. The mask may target edges depicted within the visual content.

The blur component may be configured to generate blurred visual content. The blurred visual content may be generated based on blurring of the edges depicted within visual content using the mask and/or other information. The blurring of the edges depicted within the visual content may blur the halo artifact.

The high-fidelity component may be configured to generate high-fidelity visual content. The high-fidelity visual content may be based on enhancement of the blurred visual content. The high-fidelity visual content may include more detailed depiction of the object(s) than the visual content. The high-fidelity visual content may depict the object(s) with a reduced halo artifact. The reduced halo artifact may have a smaller visual impact than the halo artifact.

In some implementations, the enhancement of the blurred visual content may include application of super-resolution to the blurred visual content. In some implementations, the enhancement of the blurred visual content may include application of sharpening to the blurred visual content.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for reducing halo artifacts.

FIG. 2 illustrates an example method for reducing halo artifacts.

FIG. 3 illustrates an example image capture device.

FIG. 4 illustrates an example image with and without halo artifacts.

FIG. 5 illustrates an example blurring of halo artifacts within an image.

FIG. 6 illustrates an example reduction of halo artifacts within an image.

### DETAILED DESCRIPTION

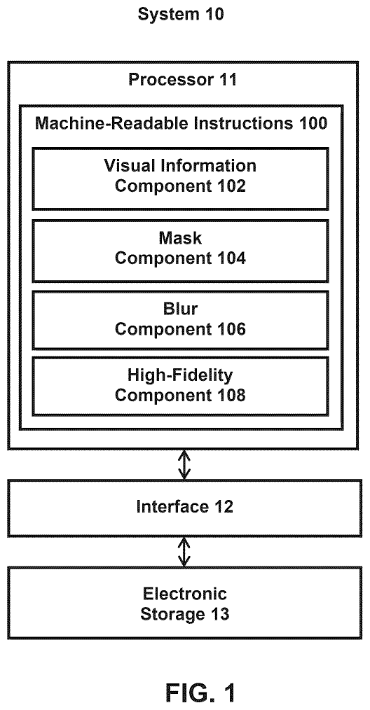

FIG. 1 illustrates a system 10 for reducing halo artifacts. The system 10 may include one or more of a processor 11, an interface 12 (e.g., bus, wireless interface), an electronic storage 13, and/or other components. In some implementations, the system 10 may include one or more optical elements, one or more image sensors, and/or other components. Visual information and/or other information may be obtained by the processor 11. The visual information may define visual content of one or more images. The visual content may depict one or more objects with a halo artifact. A mask for the visual content may be generated by the processor 11. The mask may be generated to target edges depicted within the visual content. Blurred visual content may be generated by the processor 11 based on blurring of the edges depicted within visual content using the mask. The blurring of the edges depicted within the visual content may blur the halo artifact. High-fidelity visual content may be generated by the processor 11 based on enhancement of the blurred visual content. The high-fidelity visual content may include more detailed depiction of the object(s) than the visual content. The high-fidelity visual content may depict the object(s) with a reduced halo artifact. The reduced halo artifact may have a smaller visual impact than the halo artifact.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store visual information, information relating to visual content, information relating to halo artifacts, information relating to masks, information relating to blurring visual content, information relating to enhancement of visual content, and/or other information.

Visual content may refer to content of image(s) (e.g., single image, burst images, video frame(s), and/or video(s)) that may be consumed visually. For example, visual content may be included within one or more images and/or one or more video frames of a video. The video frame(s) may define/contain the visual content of the video. That is, video may include video frame(s) that define/contain the visual content of the video. Video frame(s) may define/contain visual content viewable as a function of progress through the progress length (duration, number of frames) of the video. A video frame may include an image of visual content at a moment within the progress length of the video. As used herein, the term video frame may be used to refer to one or more of an image frame, frame of pixels, encoded frame (e.g., I-frame, P-frame, B-frame), and/or other types of video frame. Visual content may be generated based on light received within a field of view of a single image sensor or within fields of view of multiple image sensors.

Visual content (of image(s), of video frame(s), of video(s)) with a field of view may be captured by an image capture device. A field of view of visual content may define a field of view of a scene captured within the visual content. A field of view of visual content may refer to an extent of a scene captured and/or viewable within the visual content. A field of view of visual content may refer to a part of a scene from which light is received for generation of the visual content. For example, an image may include a wide field of view image, such as a panoramic image or a spherical image, and the field of view may of the image may include a wide field of view (e.g., greater than 120 degrees, 360 degrees). Other fields of view are contemplated.

Visual content may be stored in one or more formats and/or one or more containers. A format may refer to one or more ways in which the information defining visual content is arranged/laid out (e.g., file format). A container may refer to one or more ways in which information defining visual content is arranged/laid out in association with other information (e.g., wrapper format). Information defining visual content (visual information) may be stored within a single file or multiple files. For example, visual information defining an image or video frames of a video may be stored within a single file (e.g., image file, video file), multiple files (e.g., multiple image files, multiple video files), a combination of different files, and/or other files.

The system 10 may be remote from the image capture device or local to the image capture device. For example, the system 10 may be implemented within a computing device (e.g., mobile device, desktop device) separate from the image capture device. The system 10 may be implemented within an image capture device. One or more portions of the image capture device may be remote from or a part of the system 10. One or more portions of the system 10 may be remote from or a part of the image capture device. For example, one or more components of the system 10 may be carried by a housing, such as a housing of an image capture device. For instance, optical element(s) and/or image sensor(s) of the system 10 may be carried by the housing of the image capture device. The housing may carry other components, such as the processor 11 and/or the electronic storage 13. References to a housing of an image capture device may refer to the image capture device, and vice versa.

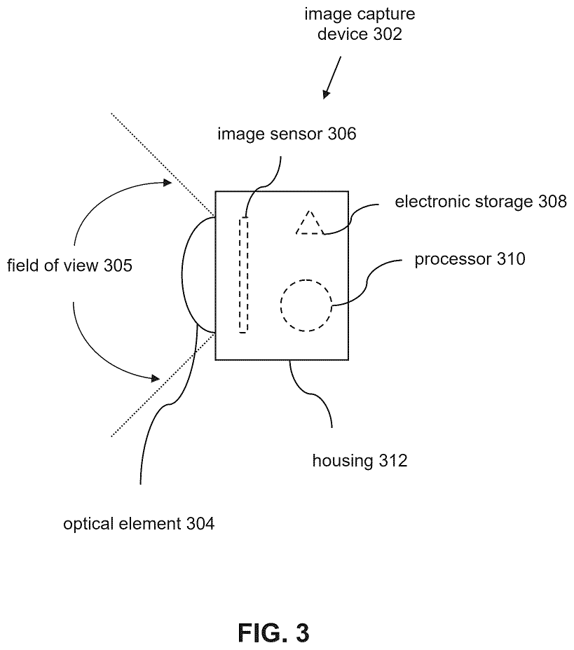

An image capture device may refer to a device that captures visual content. An image capture device may capture visual content in the form of images, videos, and/or other forms. An image capture device may refer to a device for recording visual information in the form of images, videos, and/or other media. An image capture device may be a standalone device (e.g., camera, action camera, image sensor) or may be part of another device (e.g., part of a smartphone, tablet). FIG. 3 illustrates an example image capture device 302. Visual content may be captured by the image capture device 302. The image capture device 302 may include a housing 312. The housing 312 may refer a device (e.g., casing, shell) that covers, protects, and/or supports one or more components of the image capture device 302. The housing 312 may include a single-piece housing or a multi-piece housing. The housing 312 may carry (be attached to, support, hold, and/or otherwise carry) one or more of an optical element 304, an image sensor 306, an electronic storage 308, a processor 310, and/or other components.

One or more components of the image capture device 302 may be the same as, be similar to, and/or correspond to one or more components of the system 10. For example, the electronic storage 308 may be the same as, be similar to, and/or correspond to the electronic storage 13. The processor 310 may be the same as, be similar to, and/or correspond to the processor 11. The image capture device 302 may include other components not shown in FIG. 3, such as one or more sound sensors. The sound sensor(s) may be used by the image capture device 302 to capture audio content. The image capture device 302 may not include one or more components shown in FIG. 3. Other configurations of image capture devices are contemplated.

The optical element 304 may include instrument(s), tool(s), and/or medium that acts upon light passing through the instrument(s)/tool(s)/medium. For example, the optical element 304 may include one or more of lens, mirror, prism, and/or other optical elements. The optical element 304 may affect direction, deviation, and/or path of the light passing through the optical element 304. The optical element 304 may have a field of view 305. The optical element 304 may be configured to guide light within the field of view 305 to the image sensor 306.

The field of view 305 may include the field of view of a scene that is within the field of view of the optical element 304 and/or the field of view of the scene that is delivered to the image sensor 306. For example, the optical element 304 may guide light within its field of view to the image sensor 306 or may guide light within a portion of its field of view to the image sensor 306. The field of view of 305 of the optical element 304 may refer to the extent of the observable world that is seen through the optical element 304. The field of view 305 of the optical element 304 may include one or more angles (e.g., vertical angle, horizontal angle, diagonal angle) at which light is received and passed on by the optical element 304 to the image sensor 306. In some implementations, the field of view 305 may be greater than 180-degrees. In some implementations, the field of view 305 may be less than 180-degrees. In some implementations, the field of view 305 may be equal to 180-degrees.

In some implementations, the image capture device 302 may include multiple optical elements. For example, the image capture device 302 may include multiple optical elements that are arranged on the housing 312 to capture spherical images/videos (guide light within spherical field of view to one or more images sensors). For instance, the image capture device 302 may include two optical elements positioned on opposing sides of the housing 312. The fields of views of the optical elements may overlap and enable capture of spherical images and/or spherical videos.

The image sensor 306 may include sensor(s) that converts received light into output signals. The output signals may include electrical signals. The image sensor 306 may generate output signals conveying information that defines visual content of one or more images. For example, the image sensor 306 may include one or more of a charge-coupled device sensor, an active pixel sensor, a complementary metal-oxide semiconductor sensor, an N-type metal-oxide-semiconductor sensor, and/or other image sensors.

The image sensor 306 may be configured to generate output signals conveying information that defines visual content of one or more images. The image sensor 306 may be configured to generate a visual output signal based on light that becomes incident thereon during a capture duration and/or other information. The visual output signal may convey visual information that defines visual content having the field of view. The optical element 304 may be configured to guide light within the field of view 305 to the image sensor 306, and the image sensor 306 may be configured to generate visual output signals conveying visual information based on light that becomes incident thereon via the optical element 304.

The visual information may define visual content by including information that defines one or more content, qualities, attributes, features, and/or other aspects of the visual content. For example, the visual information may define visual content of an image by including information that makes up the content of the image, and/or information that is used to determine the content of the image. For instance, the visual information may include information that makes up and/or is used to determine the arrangement of pixels, characteristics of pixels, values of pixels, and/or other aspects of pixels that define visual content of the image. For example, the visual information may include information that makes up and/or is used to determine pixels of the image. Other types of visual information are contemplated.

Capture of visual content by the image sensor 306 may include conversion of light received by the image sensor 306 into output signals/visual information defining visual content. Capturing visual content may include generating, recording, storing, and/or otherwise capturing the visual content. For example, during a capture duration, the visual output signal generated by the image sensor 306 and/or the visual information conveyed by the visual output signal may be used to generate, record, store, and/or otherwise capture the visual content.

In some implementations, the image capture device 302 may include multiple image sensors. For example, the image capture device 302 may include multiple image sensors carried by the housing 312 to capture spherical images/videos based on light guided thereto by multiple optical elements. For instance, the image capture device 302 may include two image sensors configured to receive light from two optical elements positioned on opposing sides of the housing 312. The fields of views of the optical elements may overlap and enable capture of spherical images and/or spherical videos.

The processor 310 may include one or more processors (logic circuitry) that provide information processing capabilities in the image capture device 302. The processor 310 may provide one or more computing functions for the image capture device 302. The processor 310 may operate/send command signals to one or more components of the image capture device 302 to operate the image capture device 302. For example, the processor 310 may facilitate operation of the image capture device 302 in capturing image(s) and/or video(s), facilitate operation of the optical element 304 (e.g., change how light is guided by the optical element 304), and/or facilitate operation of the image sensor 306 (e.g., change how the received light is converted into information that defines images/videos and/or how the images/videos are post-processed after capture).

The processor 310 may obtain information from the image sensor 306, and/or facilitate transfer of information from the image sensor 306 to another device/component. The processor 310 may be remote from the processor 11 or local to the processor 11. One or more portions of the processor 310 may be part of the processor 11 and/or one or more portions of the processor 10 may be part of the processor 310. The processor 310 may include and/or perform one or more functionalities of the processor 11 shown in FIG. 1.

For example, the processor 310 may obtain visual information defining visual content captured through the optical element 304 by the image sensor 306. The visual content may depict one or more objects. Processing performed to generate the visual content may cause halo artifact(s) around the object(s) depicted within the visual content. For example, sharpening applied to generate the visual content may cause halo artifact(s) around the object(s) depicted within the visual content.

The halo artifact(s) within the visual content may be reduced (e.g., decreased, eliminated) to mimic the look of visual content captured by a higher performance image capture device. A mask that targets edges depicted within the visual content may be generated by the processor 310. The mask targeting edges may cover the areas of the visual content with the halo artifact(s). The halo artifact(s) may be blurred by the processor 310 while using the mask. That is, blurring that targets edges depicted within the visual content may blur the halo artifact(s).

The processor 310 may generate high-fidelity visual content may be generated by enhancing the blurred visual content (the visual content blurred using the mask). The blurred visual content may be enhanced using super-resolution, sharpening, and/or other enhancement techniques. The high-fidelity visual content may include more detailed depiction of the object(s) than the visual content. The high-fidelity visual content may depict the object(s) with reduced halo artifact(s). The reduced halo artifact(s) may have a smaller visual impact than the halo artifact(s). For example, the high-fidelity visual content may include smaller/less noticeable halo artifact(s) or halo artifacts may be eliminated from the high-fidelity visual content.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate reducing halo artifacts. The machine-readable instructions 100 may include one or more computer program components. The machine-readable instructions 100 may include one or more of a visual information component 102, a mask component 104, a blur component 106, a high-fidelity component 108, and/or other computer program components.

The visual information component 102 may be configured to obtain visual information and/or other information. Obtaining visual information may include one or more of accessing, acquiring, analyzing, determining, examining, generating, identifying, loading, locating, opening, receiving, retrieving, reviewing, selecting, storing, and/or otherwise obtaining the visual information. The visual information component 102 may obtain visual information from one or more locations. For example, the visual information component 102 may obtain visual information from a storage location, such as the electronic storage 13, electronic storage of information and/or signals generated by one or more sensors, electronic storage of a device accessible via a network, and/or other locations. The visual information component 102 may obtain visual information from one or more hardware components (e.g., an image sensor) and/or one or more software components (e.g., software running on a computing device).

In some implementations, the visual information component 102 may obtain visual information based on user interaction with a user interface/application (e.g., image/video editing application, image/video viewer application), and/or other information. For example, a user interface/application may provide option(s) for a user to select visual content in which halo artifacts are to be reduced. The visual information defining the visual content may be obtained based on the user's selection of the visual content/image through the user interface/video application. Other selections of visual content/image for retrieval of visual information are contemplated.

The visual information may define visual content of one or more images. In some implementations, the image(s) may be video frame(s) of a video. The visual content may depict one or more objects. The visual content may include depiction of one or more objects. An object may refer to a thing that can be seen. An object may include a living object or a non-living object. An object may include a static (e.g., non-moving, non-changing) object or a dynamic (moving, changing). For example, an object may include a person, an animal, a piece of equipment, a vehicle, a structure, a part of the scenery, and/or other objects.

An object within the visual content may be depicted with a halo artifact. An object depicted within the visual content may include a halo artifact around the object. An object depicted within the visual content may include a halo artifact around one or more parts of the object or entirety of the object. A halo artifact may include an increase in contrast of edges depicted within the visual content. A halo artifact may include an increase in contrast of edges of an object depicted within the visual content. A halo artifact may include an image processing artifact that results in bright and/or dark regions near edges of an object within the visual content.

In some implementations, the visual content may depict the object(s) with the halo artifact(s) based on sharpening applied to generate the visual content. Sharpening may cause edges of an object depicted within the visual content to become more defined/crisp. Sharpening may cause the lighter side of the edges to become lighter (lightening pixels on the lighter side) and/or the darker side of the edges to become darker (darkening pixels on the darker side). Sharpening may cause halo artifacts in high contrast aeras of the visual content.

In some implementations, the sharpening may be applied by an image capture device during capture of the visual content. The image capture device may apply sharpening to the visual content as the visual content is being captured and/or as part of post-capture processing of the visual content. The image capture device may apply sharpening to the visual content for viewing and/or storage. When a user opens an image for viewing (e.g., during capture, after capture), the sharpening may have already been applied to the image, resulting in halo artifact(s) within the image.

The image capture device may not provide an option for a user to adjust an amount of the sharpening applied to generate the visual content. The amount of sharpening applied to generate the visual content may not be controllable by the user. The user may only be able to turn on or turn off the sharpening, with no control over how much sharpening is applied to generate the visual content. Even if the user desires to have less sharpening applied (e.g., to reduce the halo artifacts), the image capture device may not provide any options to do so.

The image capture device may not provide an option for a user to turn off the sharpening applied to generate the visual content. The image capture device may automatically apply sharpening to generate the visual content. The user may not be able to turn off the sharpening. Even if the user desires no sharpening applied (e.g., to reduce the halo artifacts), the image capture device may not provide any options to do so.

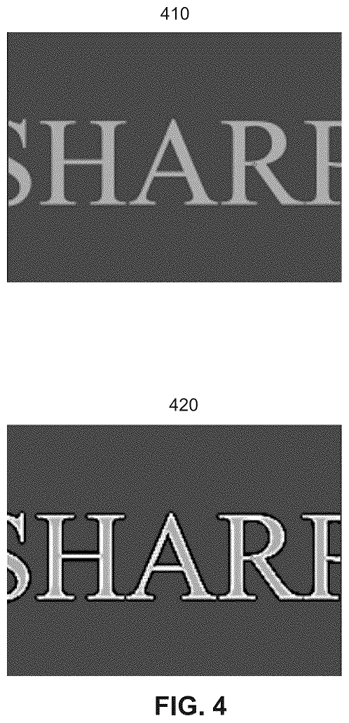

FIG. 4 illustrates example images 410, 420. The images 410, 420 may depict text. The images 410, 420 may depict a part of the ward “SHARP.” The image 410 may not include any halo artifacts around the text. The image 420 may include halo artifacts around the text. The image 420 may include halo artifacts around the text as a result of sharpening. For example, the image 420 may be generated based on sharpening applied to the image 410.

The mask component 104 may be configured to generate one or more masks for the visual content. Generating a mask may include creating, making, producing, storing, and/or otherwise generating the mask. A mask for visual content may refer to an image/layer whose pixel value (e.g., intensity value) is used to select one or more areas of the visual content (e.g., for processing). A mask for visual content may be used to limit/control which areas of the visual content are processed (e.g., blurred).

A mask may be generated to target edges depicted within the visual content. A mask may be generated to enable selection of edges depicted within the visual content. A mask may be generated to enable visual content processing (e.g., blurring) to be limited/control to areas of the visual content that depict edges. For example, a mask may be generated by running one or more edge filters on the visual content. A mask may be generated by detecting boundaries between areas of the visual content that have distinctly different brightness. Other generation of mask(s) is contemplated.

The blur component 106 may be configured to generate blurred visual content. Generating blurred visual content may include creating, making, producing, storing, and/or otherwise generating the blurred visual content. Blurred visual content may refer to visual content that has been blurred. Blurred visual content may refer to visual content in which blurring has been applied. Blurred visual content may refer to visual content that has been modified via blurring.

The blurred visual content may be generated using the mask(s) for the visual content. The blurred visual content may be generated based on blurring of the edges depicted within visual content using the mask(s) and/or other information. Use of the mask(s) on the visual content may select the edges depicted within visual content for blurring. Use of the mask(s) on the visual content may limit/control blurring of the visual content to areas of the visual content that depict edges. The mask(s) may be used to find/target the edges depicted within the visual content for blurring.

Blurring the visual content may include making the visual content less distinct. Blurring the visual content may include making the visual content less sharp. Blurring the visual content may include reducing the level of detail within the visual content. With the mask(s) applied to the visual content, the visual content may be blurred to make the areas of the visual content that depict edges to become less distinct, become less sharp, include less detail, and/or otherwise become blurred. The blurring of the edges depicted within the visual content may blur the halo artifacts. That is, application of blurring with the mask(s) may blur the halo artifacts within the visual content while preserving other depictions within the visual content. Blurring the halo artifacts may include average the two sides (darker side, lighter side) of the halo artifacts to reduce the visual impact (e.g., size, distinctness) of the halo artifacts. Blurring the halo artifacts may average undesired characteristics (e.g., high contrast edges) of the visual content while preserving desired characteristics (e.g., existence of edges/borders) of the visual content.

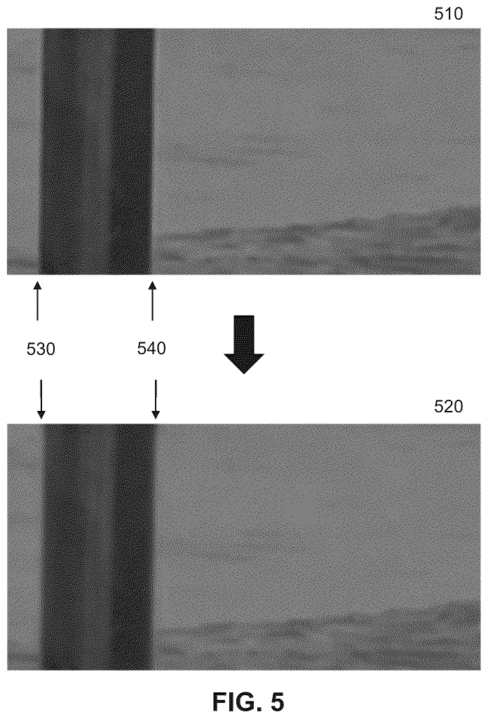

FIG. 5 illustrates an example blurring of halo artifacts within an image 510. The image 510 may depict a pillar in the ocean. The image 510 may depict the pillar with halo artifacts on the left side 530 and right side 540 of the pillar. A mask for the halo artifacts on the left side 530 and right side 530 of the pillar may be generated (e.g., using edge filter(s). A blurred image 520 may be generated from the image 510. The blurred image 520 may be generated by applying the mask to the image 510 to target the left side 530 and right side 540 of the pillar (depicting the halo artifacts) and then applying blurred to the masked image. The blurred image 520 may depict the pillar with blurred halo artifacts. The halo artifacts on the left side 530 and right side 540 of the pillar may be reduced (e.g., decreased, eliminated) within the blurred image 550. Blurring may reduce high contrast edges on the left side 530 and right side 540 of the pillar, while retaining the general edges/borders of the pillar.

The high-fidelity component 108 may be configured to generate high-fidelity visual content. Generating high-fidelity visual content may include creating, making, producing, storing, and/or otherwise generating the high-fidelity visual content. High-fidelity visual content may refer to visual content in which fidelity of depictions has been increased. High-fidelity visual content may refer to visual content in which one or more enhancement (fidelity enhancement) has been applied. High-fidelity visual content may refer to visual content that has been modified via enhancement. High-fidelity visual content may be generated to replace the original visual content or the blurred visual content. High-fidelity visual content may be generated as a different version of the visual content.

The high-fidelity visual content may be based on enhancement of the blurred visual content. Enhancement of the blurred visual content may refer to modification of the blurred visual content to improvement the fidelity of the blurred visual content. Enhancement of the fidelity of the visual content may refer to an increase in accuracy of how the visual content depicts objects. For example, enhancement of the visual content may increase the number of resolution/pixels used for depiction of object(s) in the visual content, increase the sharpness of the visual content, increase the color accuracy of the visual content, increase the texture accuracy of the visual content, increase the amount of details depicted (e.g., highlight detail, shadow detail) in the visual content, reduce the amount of noise in the visual content, and/or increase other fidelity of the visual content. In some implementations, the enhancement of the blurred visual content may include application of super-resolution to the blurred visual content. Super-resolution may refer to one or more techniques that enhance/increase the resolution of the visual content. Super-resolution may refer to one or more techniques that enhance/increase the details of objected depicted within the visual content. In some implementations, the enhancement of the blurred visual content may include application of sharpening to the blurred visual content. Sharpening may refer to one or more techniques that enhance/increase the apparent sharpness of the visual content. Sharpening may refer to one or more techniques that enhance/increase the apparent sharpness of the details of objected depicted within the visual content. Other types of enhancement of the visual content are contemplated.

The high-fidelity visual content may depict the object(s) with reduced halo artifact(s). The high-fidelity visual content depicting an object with a reduced halo artifact may include the high-fidelity visual content including smaller/less noticeable halo artifact around the object than the visual content. The high-fidelity visual content depicting an object with a reduced halo artifact may include the halo artifact in the original visual content being decreased in the high-fidelity visual content or being eliminated from the high-fidelity visual content.

The reduced halo artifact(s) within the high-fidelity visual content may have a smaller visual impact than the halo artifact(s) within the original visual content. The reduced halo artifact(s) within the high-fidelity visual content may have less effect on viewing of the high-fidelity visual content than the halo artifact(s) within the original visual content. The reduced halo artifact(s) within the high-fidelity visual content may have smaller size and/or distinctness than the halo artifact(s) within the original visual content.

In some implementations, the high-fidelity visual content may include more detailed depiction of the object(s) than the visual content. For example, the high-fidelity visual content may depict the object(s) with higher resolution/pixels, higher sharpness, higher color accuracy, higher texture accuracy, higher detail, less noise, and/or other higher fidelity characteristics than the original visual content.

In some implementations, the high-fidelity visual content may include the same/about the same level of depiction of the object(s) as the visual content. For example, the resolution/pixels, sharpness, color accuracy, texture accuracy, detail, noise, and/or other fidelity characteristics of the high-fidelity visual content may be the same or about the same (e.g., within a threshold amount of difference) as the visual content. The difference between the original visual content and the high-fidelity visual content may be that the halo artifact(s) within the original visual content may be reduced within the high-fidelity visual content. Such high-fidelity visual content may simulate the fidelity level expected from the image capture device that captured the visual content, without/with less the halo artifacts.

For example, after enhancement of the visual content, the enhanced visual content may be combined (e.g., mixed) with the original visual content. The mask(s) for the visual content that targets the edges may be used on combining the enhanced visual content with the original visual content to reduce the halo artifacts within the combined visual content.

As another example, fidelity of the visual content may be intentionally reduced. For example, the resolution of the visual content may be reduced prior to blurring of the visual content and/or prior to use of super-resolution to increase the resolution. Super-resolution may be used to increase the resolution and match the resolution of the high-fidelity visual content with the resolution of the original visual content.

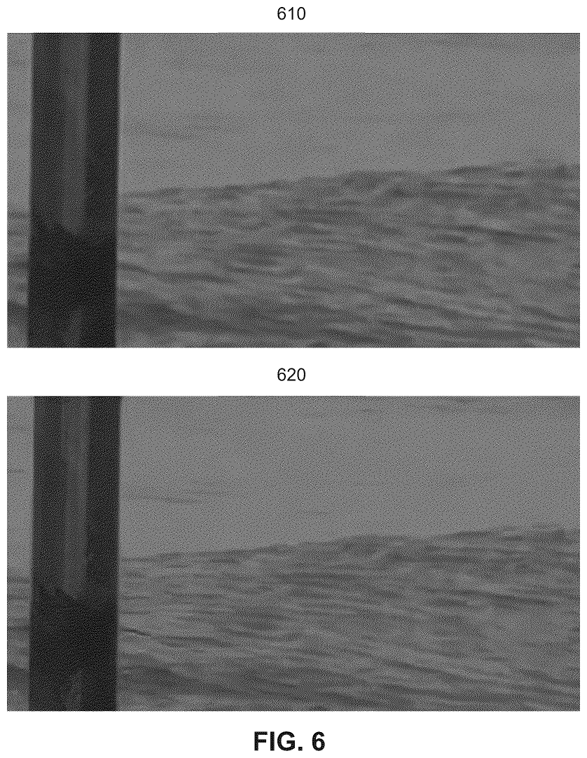

FIG. 6 illustrates an example reduction of halo artifacts within an image. An image 610 may depict a pillar in the ocean. The image 610 may depict the pillar with halo artifacts on the left side and right side of the pillar. A mask may be generated to target the edges within the image 610 and blurring may be applied. Afterwards, enhancement may be applied to the blurred image to generate a high-fidelity image 620. The high-fidelity image 620 may depict the pillar with reduced halo artifacts. The reduced halo artifacts may have a smaller visual impact on the high-fidelity image 620 than the halo artifacts on the image 610. The high-fidelity image 620 may include more detailed depiction of the pillar (and other things, such as waves in the ocean) than the image 610.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible (non-transitory) machine-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11 and the electronic storage 13 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, Li-Fi communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which processor 11 comprises multiple processing units, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

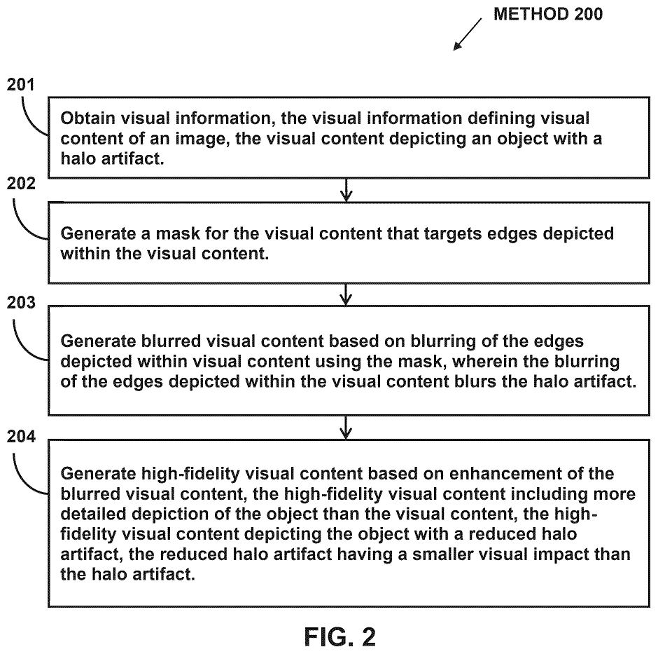

FIG. 2 illustrates method 200 for reducing halo artifacts. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 201, visual information and/or other information may be obtained. The visual information may define visual content of one or more images. The visual content may depict one or more objects with a halo artifact. In some implementations, operation 201 may be performed by a processor component the same as or similar to the visual information component 102 (Shown in FIG. 1 and described herein).

At operation 202, a mask for the visual content may be generated. The mask may be generated to target edges depicted within the visual content. In some implementations, operation 202 may be performed by a processor component the same as or similar to the mask component 104 (Shown in FIG. 1 and described herein).

At operation 203, blurred visual content may be generated based on blurring of the edges depicted within visual content using the mask. The blurring of the edges depicted within the visual content may blur the halo artifact. In some implementations, operation 203 may be performed by a processor component the same as or similar to the blur component 106 (Shown in FIG. 1 and described herein).

At operation 204, high-fidelity visual content may be generated based on enhancement of the blurred visual content. The high-fidelity visual content may include more detailed depiction of the object(s) than the visual content. The high-fidelity visual content may depict the object(s) with a reduced halo artifact. The reduced halo artifact may have a smaller visual impact than the halo artifact. In some implementations, operation 204 may be performed by a processor component the same as or similar to the high-fidelity component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for reducing halo artifacts, the system comprising:
one or more physical processors configured by machine-readable instructions to:
obtain visual information, the visual information defining visual content of an image, the visual content depicting an object with a halo artifact, the halo artifact including an increase in contrast of the edges depicted within the visual content, wherein the visual content depicts the object with the halo artifact based on sharpening applied to generate the visual content;
generate a mask for the visual content that targets edges depicted within the visual content;
generate blurred visual content based on blurring of the edges depicted within visual content using the mask, wherein the blurring of the edges depicted within the visual content blurs the halo artifact; and
generate high-fidelity visual content based on enhancement of the blurred visual content, the high-fidelity visual content including more detailed depiction of the object than the visual content, the high-fidelity visual content depicting the object with a reduced halo artifact, the reduced halo artifact having a smaller visual impact than the halo artifact.

2. The image capture device of claim 1, wherein:
the sharpening is applied by an image capture device during capture of the visual content; and
the image capture device does not provide a first option for a user to adjust an amount of the sharpening applied to generate the visual content or does not provide a second option for the user to turn off the sharpening applied to generate the visual content.

3. A system for reducing halo artifacts, the system comprising:
one or more physical processors configured by machine-readable instructions to:
obtain visual information, the visual information defining visual content of an image, the visual content depicting an object with a halo artifact;
generate a mask for the visual content that targets edges depicted within the visual content;
generate blurred visual content based on blurring of the edges depicted within visual content using the mask, wherein the blurring of the edges depicted within the visual content blurs the halo artifact; and
generate high-fidelity visual content based on enhancement of the blurred visual content, the high-fidelity visual content including more detailed depiction of the object than the visual content, the high-fidelity visual content depicting the object with a reduced halo artifact, the reduced halo artifact having a smaller visual impact than the halo artifact.

4. The system of claim 3, wherein the halo artifact includes an increase in contrast of the edges depicted within the visual content.

5. The system of claim 3, wherein the visual content depicts the object with the halo artifact based on sharpening applied to generate the visual content.

6. The system of claim 5, wherein the sharpening is applied by an image capture device during capture of the visual content.

7. The system of claim 6, wherein the image capture device does not provide an option for a user to adjust an amount of the sharpening applied to generate the visual content.

8. The system of claim 6, wherein the image capture device does not provide an option for a user to turn off the sharpening applied to generate the visual content.

9. The system of claim 3, wherein the enhancement of the blurred visual content includes application of super-resolution to the blurred visual content.

10. The system of claim 3, wherein the enhancement of the blurred visual content includes application of sharpening to the blurred visual content.

11. The system of claim 3, wherein the image is a video frame of a video.

12. A method for reducing halo artifacts, the method performed by a computing system including one or more processors, the method comprising:
obtaining, by the computing system, visual information, the visual information defining visual content of an image, the visual content depicting an object with a halo artifact;
generating, by the computing system, a mask for the visual content that targets edges depicted within the visual content;
generating, by the computing system, blurred visual content based on blurring of the edges depicted within visual content using the mask, wherein the blurring of the edges depicted within the visual content blurs the halo artifact; and
generating, by the computing system, high-fidelity visual content based on enhancement of the blurred visual content, the high-fidelity visual content including more detailed depiction of the object than the visual content, the high-fidelity visual content depicting the object with a reduced halo artifact, the reduced halo artifact having a smaller visual impact than the halo artifact.

13. The method of claim 12, wherein the halo artifact includes an increase in contrast of the edges depicted within the visual content.

14. The method of claim 12, wherein the visual content depicts the object with the halo artifact based on sharpening applied to generate the visual content.

15. The method of claim 14, wherein the sharpening is applied by an image capture device during capture of the visual content.

16. The method of claim 15, wherein the image capture device does not provide an option for a user to adjust an amount of the sharpening applied to generate the visual content.

17. The method of claim 15, wherein the image capture device does not provide an option for a user to turn off the sharpening applied to generate the visual content.

18. The method of claim 12, wherein the enhancement of the blurred visual content includes application of super-resolution to the blurred visual content.

19. The method of claim 12, wherein the enhancement of the blurred visual content includes application of sharpening to the blurred visual content.

20. The method of claim 12, wherein the image is a video frame of a video.
